(19) United States
(12) Patent Application Publication
(10) Pub. No.: US 2024/0204536 A1
(43) Pub. Date: Jun. 20, 2024

(54) VEHICLE, METHOD AND SYSTEM FOR CONTROLLING THE SAME

(71) Applicants: Hyundai Motor Company, Seoul (KR); Kia Corporation, Seoul (KR)

(72) Inventors: Jihye LEE, Hwaseong-Si (KR); Jeongmin Kim, Gwangmyeong-Si (KR); Seokgyu Kim, Seongnam-Si (KR); Sinjung Kim, Suwon-Si (KR)

(73) Assignees: Hyundai Motor Company, Seoul (KR); Kia Corporation, Seoul (KR)

(21) Appl. No.: 18/240,268

(22) Filed: Aug. 30, 2023

(30) Foreign Application Priority Data
Dec. 19, 2022 (KR) 10-2022-0178282

(51) Int. Cl. H02J 7/00; G07C 9/00

(52) U.S. Cl. CPC H02J 7/00045; G07C 9/00309; H02J 7/00034; G07C 2009/00507

(57) ABSTRACT

A vehicle may include: a display; a wireless charger configured to operate in a charging mode for charging a mobile device or in a proximity communication mode for communicating with the mobile device; and a controller communicatively connected to the display and the wireless charger and configured to control the display and the wireless charger, wherein the controller is configured to: identify a placement of the mobile device on the wireless charger, determine, based on whether a predetermined activation condition is satisfied, whether a digital key registration mode is activated, operate, in response that the digital key registration mode is activated, the wireless charger in the proximity communication mode, perform registration of a digital key using digital key data obtained from the mobile device, and control the display to provide information related to the digital key registration.

### CROSS-REFERENCE TO RELATED APPLICATION(S)

The present application claims priority to Korean Patent Application No. 10-2022-0178282, filed on Dec. 19, 2022, the entire contents of which is incorporated herein for all purposes by this reference.

### BACKGROUND OF THE PRESENT DISCLOSURE

### Field of the Present Disclosure

The present disclosure relates to a vehicle capable of registering a digital key by communicating with a mobile device, and a method and system for controlling the same.

### Description of Related Art

In general, smart keys are provided as an authentication means for a vehicle. In addition to the smart keys, digital keys stored in mobile devices are also provided. To use such a digital key, a process of registering the digital key with a vehicle is required. Conventionally, to register a digital key, a user is required to manipulate both an input device (e.g., an audio/video/navigation (AVN) device) provided in a vehicle and a mobile device owned by the user. Furthermore, related art only allows a digital key registration when a vehicle is switched off, so that users may feel inconvenienced by the conventional digital key registration method.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a vehicle configured for conveniently registering a digital key using a mobile device and a wireless charger disposed in the vehicle, and a method and system for controlling the vehicle.

Another aspect of the present disclosure provides a vehicle configured for switching an operation mode of the wireless charger so that a digital key registration may be performed in a state where an ignition of the vehicle is turned on, and a method and system for controlling the vehicle.

Additional aspects of the present disclosure are set forth in part in the description which follows, and in part, should be understood from the description, or may be learned by practice of the present disclosure.

In accordance with an aspect of the present disclosure, a vehicle includes a display, a wireless charger configured to operate in a charging mode for charging a mobile device or in a proximity communication mode for communicating with the mobile device, and a controller communicatively connected to the display and the wireless charger and configured to control the display and the wireless charger, wherein the controller is configured to identify a placement of the mobile device on the wireless charger, determine, based on whether a predetermined activation condition is satisfied, whether a digital key registration mode is activated, operate, in response that the digital key registration mode is activated, the wireless charger in the proximity communication mode, perform registration of a digital key using digital key data obtained from the mobile device, and control the display to provide information related to the digital key registration.

The controller may deactivate the digital key registration mode in response that the predetermined activation condition is not satisfied or the digital key data is not obtained from the mobile device, and re-determine whether the digital key registration mode is activated based on the mobile device being placed back after being disconnected from the wireless charger.

The vehicle may further include a smart key sensor configured to identify a smart key, wherein the controller may, in response that an ignition of the vehicle is turned on, the smart key is detected in the vehicle while parked, and a preparation signal is received from the mobile device, conclude that the activation condition is satisfied, and activate the digital key registration mode.

The controller may be configured for controlling the display to provide a notification of a non-preparation state of the mobile device in response to a failure to receive the preparation signal from the mobile device.

The controller may be configured for controlling the display to provide a notification of an absence of the digital key data in response to a failure to obtain the digital key data from the mobile device.

The controller may operate the wireless charger in the charging mode in response that the digital key registration mode is deactivated and the ignition of the vehicle is turned on.

In accordance with another aspect of the present disclosure, a method of controlling a vehicle is provided. The method includes identifying whether a mobile device is placed on a wireless charger, determining, by a controller, whether a digital key registration mode is activated based on whether a predetermined activation condition is satisfied, operating the wireless charger in a proximity communication mode in response that the digital key registration mode is activated, performing, by the controller, registration of a digital key using digital key data obtained from the mobile device, and providing, by a display, information related to the digital key registration.

The method may further include deactivating the digital key registration mode in response that the predetermined activation condition is not satisfied or the digital key data is not obtained from the mobile device, and re-determining whether the digital key registration mode is activated based on the mobile device being placed back after being disconnected from the wireless charger.

The determining of whether to activate the digital key registration mode may further include, in response to an ignition of the vehicle being turned on, a smart key being detected in the vehicle while parked, and a preparation signal being received from the mobile device, determining that the activation condition is satisfied, and activating the digital key registration mode.

The providing of information related to the digital key registration may further include providing a notification of a non-preparation state of the mobile device in response to a failure to receive the preparation signal from the mobile device.

The providing of information related to the digital key registration may further include providing a notification of the absence of the digital key data in response to a failure to obtain the digital key data from the mobile device.

The method may further include operating the wireless charger in a charging mode in response that the digital key registration mode is deactivated and the ignition of the vehicle is turned on.

In accordance with yet another aspect of the present disclosure, a system includes a mobile device, and a vehicle including a wireless charger and a display, wherein the vehicle is configured to identify a placement of the mobile device on the wireless charger, determine whether a digital key registration mode is activated based on whether a predetermined activation condition is satisfied, operate the wireless charger in a proximity communication mode in response that the digital key registration mode is activated, perform registration of a digital key using digital key data obtained from the mobile device, and control the display to provide information related to the digital key registration.

The vehicle may further deactivate the digital key registration mode in response that the predetermined activation condition is not satisfied or the digital key data is not obtained from the mobile device, and re-determine whether the digital key registration mode is activated based on the mobile device being placed back after being disconnected from the wireless charger.

The vehicle may Furthermore, in response that an ignition of the vehicle is turned on, a smart key is detected in the vehicle while parked, and a preparation signal is received from the mobile device, conclude that the activation condition is satisfied, and activate the digital key registration mode.

The vehicle may further control the display to provide a notification of a non-preparation state of the mobile device in response to a failure to receive the preparation signal from the mobile device.

The vehicle may further control the display to provide a notification of an absence of the digital key data in response to a failure to obtain the digital key data from the mobile device.

The vehicle may further operate the wireless charger in a charging mode in response that the digital key registration mode is deactivated and an ignition of the vehicle is turned on.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a control block diagram illustrating a system according to an exemplary embodiment of the present disclosure;

FIG. 2 is a flowchart illustrating a method for controlling a vehicle according to an exemplary embodiment of the present disclosure;

FIG. 3 is a view exemplarily illustrating a method of activating a digital key registration mode described in FIG. 2 in detail;

FIG. 4 is a view additionally illustrating one example of a method of providing information on the digital key registration described in FIG. 2; and

FIG. 5 is a view additionally illustrating an operation of a wireless charger in an inactive state of the digital key registration mode described in FIG. 2.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Reference is made below in detail to the exemplary embodiments of the present disclosure, examples of which are illustrated in the accompanying drawings, wherein like reference numerals refer to like elements throughout. This specification does not describe all elements of the disclosed exemplary embodiments and detailed descriptions of what is well known in the art or redundant descriptions on substantially the same configurations have been omitted. The terms ‘part’, ‘module’, ‘member’, ‘block’ and the like as used in the specification may be implemented in software or hardware. Furthermore, a plurality of ‘part’, ‘module’, ‘member’, ‘block’ and the like may be embodied as one component. It is also possible that one ‘part’, ‘module’, ‘member’, ‘block’ and the like includes a plurality of components.

Throughout the specification, when an element is referred to as being “connected to” another element, it may be directly or indirectly connected to the other element and the “indirectly connected to” includes being connected to the other element via a wireless communication network.

Also, it is to be understood that the terms “include” and “have” are intended to indicate the existence of elements included in the specification, and are not intended to preclude the possibility that one or more other elements may exist or may be added.

Throughout the specification, when a member is located “on” another member, this includes not only when one member is in contact with another member but also when another member is present between the two members.

The terms first, second, and the like are used to distinguish one component from another component, and the component is not limited by the terms described above.

An expression used in the singular encompasses the expression of the plural, unless it includes a clearly different meaning in the context.

The reference numerals used in operations are used for descriptive convenience and are not intended to describe the order of operations and the operations may be performed in a different order unless otherwise stated.

When a component, device, element, or the like of the present disclosure is described as having a purpose or performing an operation, function, or the like, the component, device, or element should be considered herein as being “configured to” meet that purpose or to perform that operation or function.

Hereinafter, various embodiments of the present disclosure are described in detail with reference to the accompanying drawings.

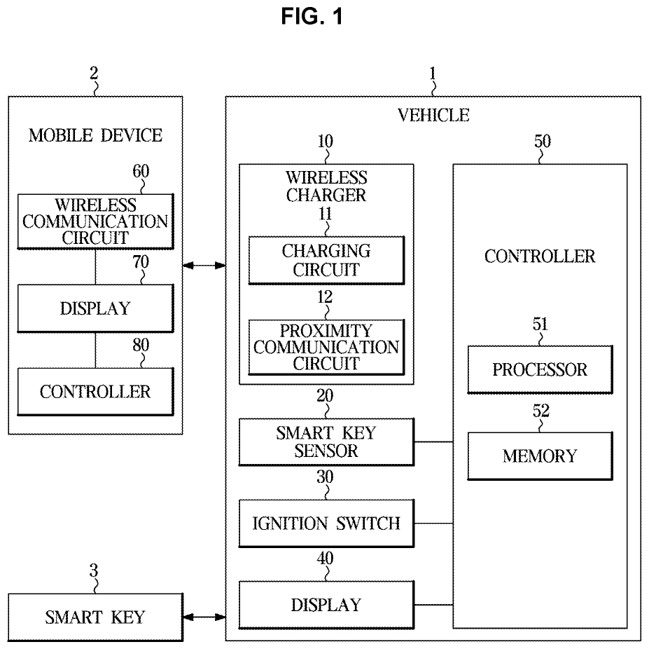

FIG. 1 is a control block diagram illustrating a system according to an exemplary embodiment of the present disclosure.

Referring to FIG. 1, a system according to an exemplary embodiment of the present disclosure may include a vehicle 1, a mobile device 2, and a smart key 3. The vehicle 1 may communicate wirelessly with the mobile device 2. The vehicle 1 may communicate with the smart key 3 wirelessly.

The mobile device 2 may include various portable electronic devices. For example, the mobile device 2 may be a smartphone. The mobile device 2 may include a wireless communication circuit 60, a display 70, and a controller 80. The controller 80 of the mobile device 2 is electrically connected to components of the mobile device 2 and may be configured for controlling an operation of the mobile device 2.

To avoid confusion of terms, a controller 50 of the vehicle 1 may be referred to as a first controller, and the controller 80 of the mobile device 2 may be referred to as a second controller. A display 40 of the vehicle 1 may be referred to as a first display, and the display 70 of the mobile device 2 may be referred to as a second display.

The wireless communication circuitry 60 of the mobile device 2 may include a short-range wireless communication circuitry and a long-range wireless communication circuitry. The wireless communication circuitry 60 of the mobile device 2 may perform a short-range wireless communication and/or a long-range wireless communication with other devices (e.g., a vehicle, any other mobile device).

The display 70 of the mobile device 2 may display various information and/or screens associated with an operation of the mobile device 70. When the controller 80 of the mobile device 2 executes an application for a digital key registration, the display 70 of the mobile device 70 may display a user interface for the digital key registration. A user interface for digital key registration may be provided as a graphical user interface (GUI) and may include a plurality of graphic elements interacting with a user input. Multiple functions of the vehicle 1 which may be executed by the smart key 3 described later may also be executed by the digital key.

The smart key 3 is a device, such as a remote control configured for performing various functions of the vehicle 1, and may be referred to as a key fob or a fob. The smart key 3 may be provided as a physical electronic device. The smart key 3 may communicate wirelessly with the vehicle 1 and trigger a plurality of operations of the vehicle 1. For example, the smart key 3 may perform a door locking/unlocking function of the vehicle 1, an ignition ON/OFF function of the vehicle 1, and/or a trunk opening/closing of the vehicle 1.

The vehicle 1 may include a wireless charger 10, a smart key sensor 20, an ignition switch 30, the display 40, and the controller 50. The controller 50 is electrically connected to various devices included in the vehicle 1 and may be configured for controlling the various devices.

The various devices available on the vehicle 1 are not limited to those illustrated. For example, the vehicle 1 may include driving devices, such as an engine, a motor, a battery, wheels, a steering device, and a braking device. Furthermore, the vehicle 1 may include various convenience devices, such as a seat and an air conditioner.

The wireless charger 10 may be disposed in different locations inside the vehicle 1. For example, the wireless charger 10 may be disposed on a center fascia of the vehicle 1. The wireless charger 10 may identify whether the mobile device 2 is placed thereon. When the mobile device 2 is placed on the wireless charger 10, the wireless charger 10 may transmit a detection signal of the mobile device 2 to the controller 50. The controller 50 may identify that the mobile device 2 has been placed on the wireless charger 10 based on the detection signal transmitted from the wireless charger 10.

The wireless charger 10 may operate in a charging mode for charging the mobile device 2 or in a proximity communication mode for communicating with the mobile device 2. The wireless charger 10 may include a charging circuit 11 and a proximity communication circuit 12. When the wireless charger 10 operates in the charging mode, the battery of the mobile device 2 may be charged by power supplied from the charging circuit 11.

When the wireless charger 10 operates in the proximity communication mode, a proximity communication between the wireless charger 10 and the mobile device 2 may be established. The controller 50 of the vehicle 1 may obtain data from the mobile device 2 or transmit data to the mobile device 2 via the proximity communication circuit 12 of the wireless charger 10. The proximity communication circuit 12 of the wireless charger 10 may include a Near Field Communication (NFC) circuit.

Furthermore, although not shown in the drawings, the vehicle 1 may further include a Bluetooth communication circuit. In addition to the proximity communication circuit 12, the vehicle 1 may further include a long-range wireless communication circuit, such as a cellular communication circuit and a long-term evolution (LTE) communication circuit.

The smart key sensor 20 may detect the smart key 3 located outside or inside the vehicle 1. The smart key sensor 20 may transmit a smart key detection signal including location information of the smart key 3 to the controller 50. The controller 50 may identify the location of the smart key 3 based on the smart key detection signal. Furthermore, the smart key sensor 20 may transmit a remote signal transmitted from the smart key 3 to the controller 50.

The ignition switch 30 may be configured to generate a start signal for turning on the vehicle 1 or a stop signal for turning off the vehicle 1. When the ignition switch 30 is turned on, an ignition of the vehicle 1 is turned on, and when the ignition switch 30 is turned off, the ignition of the vehicle 1 is turned off. The controller 50 of the vehicle 1 may turn on or turn off the ignition of the vehicle 1 based on an electrical signal transmitted from the ignition switch 30.

The display 40 may be a light emitting diode (LED) panel, an organic light emitting diode (OLED) panel, or a liquid crystal display (LCD) panel. Furthermore, the display 40 may include a touch screen. The display 40 may be disposed in different positions inside the vehicle 1. For example, the display 40 may be disposed on a cluster and/or center fascia of the vehicle.

The display 40 may output various information related to a function, status and/or operation of the vehicle 1. For example, information related to digital key registration may be provided through the display 40.

The display 40 may output GUI including objects (e.g., icons, texts, images) for performing or setting functions of the vehicle 1. GUI may interact with a user input. The display 40 may output a screen corresponding to an input for an object.

Electronic components disposed in the vehicle 1 may communicate with each other via a vehicle communication network NT. For example, electronic components may exchange data via networks, such as Ethernet, Media Oriented Systems Transport (MOST), Flexray, Controller Area Network (CAN), and Local Interconnect Network (LIN).

The controller 50 may include a memory 52 that stores or temporally stores programs, instructions, and data for controlling operations of the vehicle 1, and a processor 51 that generates a control signal for controlling operations of the vehicle 1 based on the programs, instructions, and data stored/temporally stored in the memory 52. The processor 51 may include a digital processor that processes data from various sensors and a micro control unit (MCU) that generates control signals. The processor 51 and the memory 52 may be implemented as separate chips or as a single chip. Furthermore, the controller 50 may include a plurality of processors 51 and a plurality of memories 52.

The processor 51 may include a logic circuit and an arithmetic circuit, process data according to programs and/or instructions provided from the memory 52, and generate control signals according to processing results. The processor 51 may be electrically connected to various devices included in the vehicle 1.

The memory 52 may include a volatile memory, such as static random access memory (S-RAM) and dynamic RAM (D-RAM), and a nonvolatile memory, such as flash memory, read only memory (ROM), and erasable programmable read only memory (EPROM).

The controller 50 of the vehicle 1 may identify whether the mobile device 2 is placed on the wireless charger 10. The wireless charger 10 may transmit a search signal for searching the mobile device 2 and may receive a response signal of the mobile device 2 with respect to the search signal. The wireless charger 10 may transmit the search signals at a predetermined interval. The controller 50 may identify an placement of the mobile device 2 based on the response signal received by the wireless charger 10.

When the placement of the mobile device 2 on the wireless charger 10 is identified, the controller 50 of the vehicle 1 may be configured to determine whether the digital key registration mode is activated based on whether a predetermined activation condition is satisfied. Activation conditions for activating the digital key registration mode may be set in various ways. For example, the activation conditions may include turning on the vehicle 1, detecting the smart key 3 within the vehicle 1 while parked, and receiving a preparation signal from the mobile device 2.

When the ignition of the vehicle 1 is turned on, the smart key 3 is detected in the vehicle 1 while parked, and the preparation signal is received from the mobile device 2, the controller 50 of the vehicle 1 may be configured to determine that the activation condition for activating the digital key registration mode is satisfied. The controller 50 may activate the digital key registration mode as the activation condition is satisfied. Activating the digital key registration mode may mean that the vehicle 1 enters a preparation state for digital key registration.

The mobile device 2 may transmit the preparation signal as the vehicle enters the preparation state for digital key registration. The mobile device 2 may be configured to generate the preparation signal when a security code is input after an application for registering digital keys is executed. The security code may be provided through the display 40 of the vehicle 1. The controller 50 of the vehicle 1 may be configured to generate the security code for digital key registration when receiving an application execution signal from the mobile device 2 after the placement of the mobile device 2 is identified or Bluetooth communication between the mobile device 2 and the vehicle 1 is established.

Meanwhile, the controller 50 of the vehicle 1 may be configured for controlling the display 40 to provide a notification regarding a non-preparation state of the mobile device 2 based on a failure of receiving the preparation signal from the mobile device 2. For example, the display 40 may display a text message notifying the non-preparation state of the mobile device 2. The user may identify that the mobile device 2 is not in a ready state for digital key registration through the notification provided by the display 40.

If the vehicle 1 is started, the wireless charger 10 may basically operate in the charging mode. If the ignition of the vehicle 1 is turned on and other conditions are satisfied, the operation mode of the wireless charger 10 may be switched to the proximity communication mode. In other words, the controller 50 of the vehicle 1 may operate the wireless charger 10 in the proximity communication mode according to the activation of the digital key registration mode. As the wireless charger 10 operates in the proximity communication mode, the proximity communication with the mobile device 2 may be established. The controller 50 may obtain digital key data from the mobile device 2 through the wireless charger 10.

The controller 50 of the vehicle 1 may register the digital key using the digital key data obtained from the mobile device 2. The controller 50 may be configured for controlling the display 40 to provide information related to the digital key registration.

The controller 50 may be configured for controlling the display 40 to provide a notification of the absence of digital key data based on a failure to obtain the digital key data from the mobile device 2. For example, the display 40 may display a text message notifying that the digital key data is not obtained from the mobile device 2. The user may identify that the digital key data is not stored in the mobile device 2 through a notification provided by the display 40.

The controller 50 may deactivate the digital key registration mode based on dissatisfaction of the predetermined activation condition or failure to obtain the digital key data from the mobile device 2. The controller 50 may re-determine whether the digital key registration mode is activated based on the mobile device 2 being placed back after being separated (or disconnected) from the wireless charger 10.

For example, if the mobile device 2 owned by the user is not in a ready state for digital key registration, if the application of the mobile device 2 is running but the digital key data is not generated, or if a mobile phone of a passenger who is not the mobile device 2 owned by the user is placed on the wireless charger 10, the controller 50 of the vehicle 1 may deactivate the digital key registration mode. In these cases, the user may disconnect the mobile device 2 from the wireless charger 10, operate the mobile device 2 properly, and then place the mobile device 2 back on the wireless charger 10.

The controller 50 of the vehicle 1 may operate the wireless charger 10 in the charging mode when the ignition of the vehicle 1 is turned on in a state where the digital key registration mode is deactivated. When the ignition of the vehicle 1 is turned on and the mobile device 2 is placed on the wireless charger 10 in a state where the digital key registration mode is deactivated, the battery of the mobile device 2 may be charged.

Accordingly, the vehicle 1 according to an exemplary embodiment of the present disclosure may provide the user with an appropriate notification if the digital key registration fails due to various reasons. Furthermore, the vehicle 1 according to an exemplary embodiment of the present disclosure may improve security by inactivating the digital key registration mode if conditions for digital key registration are not satisfied. Furthermore, the vehicle 1 according to an exemplary embodiment of the present disclosure may switch the operation mode of the wireless charger 10 so that the vehicle 1 may perform the digital key registration even when the vehicle 1 is turned on.

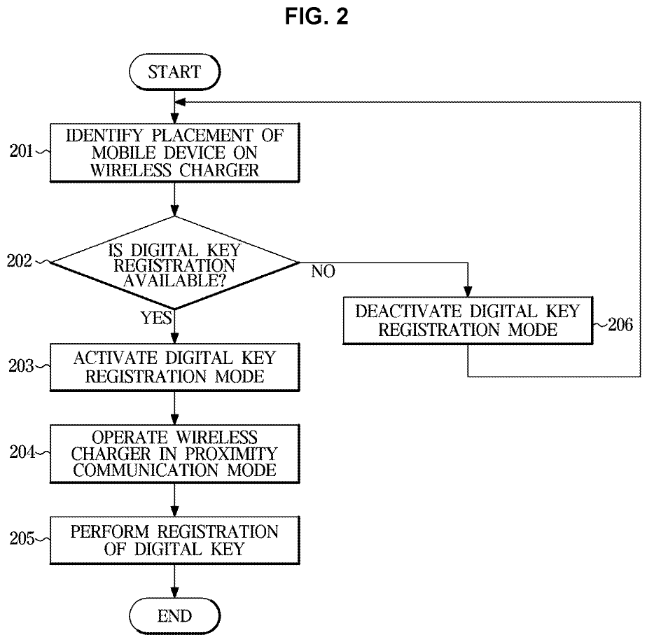

FIG. 2 is a flowchart illustrating a method of controlling a vehicle according to an exemplary embodiment of the present disclosure.

Referring to FIG. 2, the controller 50 of the vehicle 1 may identify the placement of the mobile device 2 on the wireless charger 10 (201). The controller 50 may be configured to determine whether the digital key registration is available (202). In other words, the controller 50 may activate the digital key registration mode based on whether a predetermined activation condition is satisfied. Conversely, when the activation condition for activating the digital key registration mode is not satisfied, the controller 50 may deactivate the digital key registration mode (206).

If the activation condition for activating the digital key registration mode is satisfied, the controller 50 may activate the digital key registration mode (203). The controller 50 may operate the wireless charger 10 in the proximity communication mode according to the activation of the digital key registration mode (204). The controller 50 of the vehicle 1 may perform registration of the digital key using the digital key data obtained from the mobile device 2 (205). Furthermore, the controller 50 may be configured for controlling the display 40 to provide information related to the digital key registration.

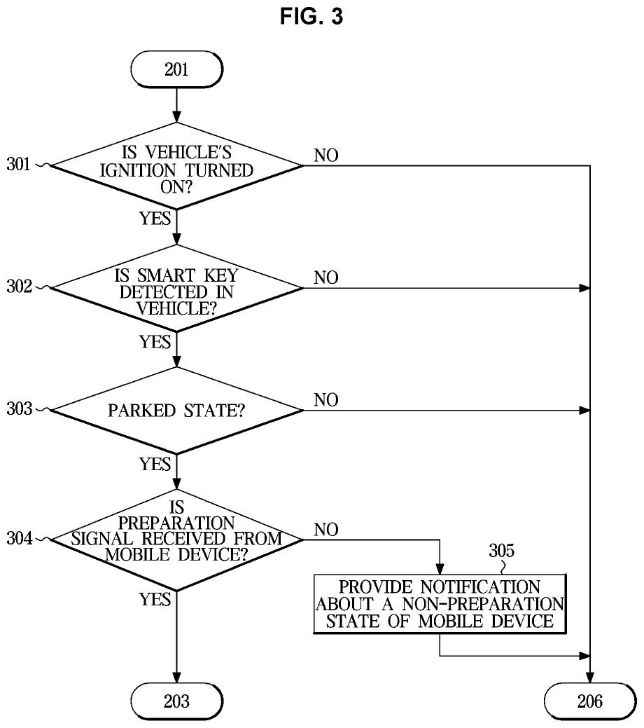

FIG. 3 is a view exemplarily illustrating the method of activating the digital key registration mode described in FIG. 2 in detail.

Referring to FIG. 3, if the ignition of the vehicle 1 is turned on (301), the smart key 3 is detected in the vehicle 1 (302), the vehicle is in the parked state (303), and the preparation signal is received from the mobile device 2 (304), the controller 50 of the vehicle 1 may be configured to determine that the activation condition for activating the digital key registration mode is satisfied. The controller 50 may activate the digital key registration mode as the activation condition is satisfied.

However, if the ignition of the vehicle 1 is turned off, the smart key 3 is not detected in the vehicle 1 (302), the vehicle is not in the parked state (303), and the preparation signal is not received from the mobile device 2 (304), the controller 50 of the vehicle 1 may deactivate the digital key registration mode (206).

The controller 50 of the vehicle 1 may be configured for controlling the display 40 to provide a notification about the non-preparation state of the mobile device 2 based on the failure of receiving the preparation signal from the mobile device 2 (305). The user may identify that the mobile device 2 is not in a ready state for digital key registration through a notification provided by the display 40.

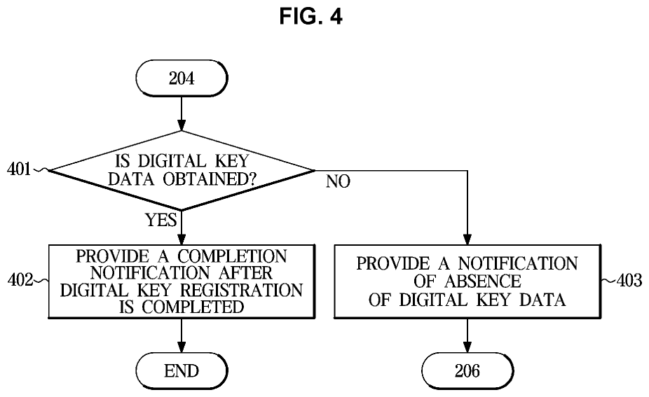

FIG. 4 is a view exemplarily illustrating an example of a method of providing information on registration of a digital key described in FIG. 2.

Referring to FIG. 4, if the digital key data is obtained from the mobile device 2 (401), the controller 50 of the vehicle 1 may register the digital key using the digital key data, and control the display 40 to provide a completion notification after the digital key registration is completed (402). For example, the notification of completion may be displayed as a text message.

However, if the digital key data is not obtained from the mobile device 2, the controller 50 of the vehicle 1 may be configured for controlling the display 40 to provide a notification of the absence of digital key data (403). For example, the display 40 may display a text message notifying that the digital key data is not obtained from the mobile device 2. Furthermore, the controller 50 may deactivate the digital key registration mode (206).

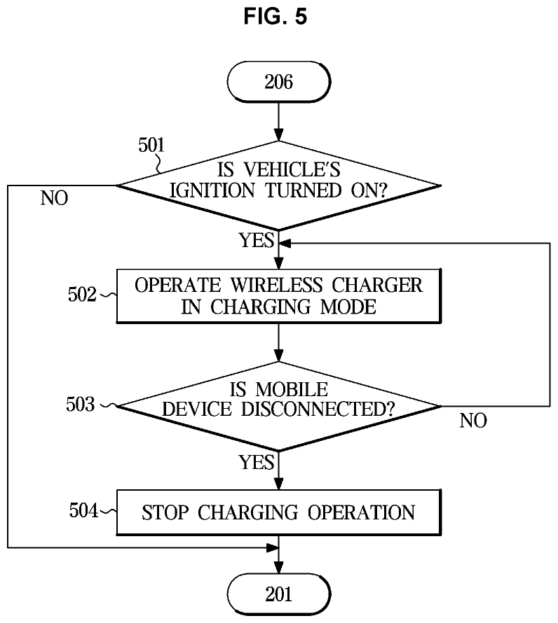

FIG. 5 is a view additionally illustrating an operation of the wireless charger in an inactive state of the digital key registration mode described in FIG. 2.

Referring to FIG. 5, if the ignition of the vehicle 1 is turned on in a state where the digital key registration mode is deactivated (501), the controller 50 of the vehicle 1 may operate the wireless charger 10 in the charging mode (502). In other words, if the ignition of the vehicle 1 is turned on and the mobile device 2 is placed on the wireless charger 10 in a state where the digital key registration mode is deactivated, the battery of the mobile device 2 may be charged.

When the mobile device 2 is disconnected from the wireless charger 10 (503), the controller 50 may be configured for controlling the wireless charger 10 to stop the charging operation (504). Accordingly, when the mobile device 2 is placed back on the wireless charger 10 (201), the controller 50 may re-determine whether the digital key registration mode is activated.

The vehicle, method and system for controlling the same according to an exemplary embodiment of the present disclosure can conveniently perform the digital key registration by use of a mobile device and the wireless charger provided in the vehicle.

The vehicle, method and system for controlling the same according to an exemplary embodiment of the present disclosure may switch the operation mode of the wireless charger so that the digital key registration may be performed in a state where the ignition of the vehicle is turned on. Therefore, user convenience may be improved.

On the other hand, the above-described embodiments may be implemented in a form of a recording medium storing instructions executable by a computer. The instructions may be stored in a form of program code. When the instructions are executed by a processor, a program module is generated by the instructions so that the operations of the disclosed exemplary embodiments of the present disclosure may be conducted. The recording medium may be implemented as a computer-readable recording medium.

The computer-readable recording medium includes all types of recording media storing data readable by a computer system. Examples of the computer-readable recording medium include a Read Only Memory (ROM), a Random Access Memory (RAM), a magnetic tape, a magnetic disk, a flash memory, an optical data storage device, or the like.

Furthermore, the term related to a control device such as “controller”, “control apparatus”, “control unit”, “control device”, “control module”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured to process data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular expression includes a plural expression unless the context clearly indicates otherwise.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A vehicle, comprising:
a display;
a wireless charger configured to operate in a charging mode for charging a mobile device or in a proximity communication mode for communicating with the mobile device; and
a controller communicatively connected to the display and the wireless charger and configured to control the display and the wireless charger;
wherein the controller is further configured to:
identify a placement of the mobile device on the wireless charger;
determine, based on whether a predetermined activation condition is satisfied, whether a digital key registration mode is activated;
operate, in response that the digital key registration mode is activated, the wireless charger in the proximity communication mode;
perform registration of a digital key using digital key data obtained from the mobile device; and
control the display to provide information related to the digital key registration.

2. The vehicle of claim 1, wherein the controller is further configured to:
deactivate the digital key registration mode in response that the predetermined activation condition is not satisfied or the digital key data is not obtained from the mobile device; and
re-determine whether the digital key registration mode is activated when the controller concludes that the mobile device is placed back after being disconnected from the wireless charger.

3. The vehicle of claim 1, further including:
a smart key sensor configured to identify a smart key;
wherein the controller is further configured to:
in response that an ignition of the vehicle is turned on, the smart key is detected in the vehicle while parked, and a preparation signal is received from the mobile device,
conclude that the activation condition is satisfied; and
activate the digital key registration mode.

4. The vehicle of claim 3, wherein the controller is further configured to control the display to provide a notification of a non-preparation state of the mobile device in response to a failure to receive the preparation signal from the mobile device.

5. The vehicle of claim 1, wherein the controller is further configured to control the display to provide a notification of an absence of the digital key data in response to a failure to obtain the digital key data from the mobile device.

6. The vehicle of claim 1, wherein the controller is further configured to operate the wireless charger in the charging mode in response that the digital key registration mode is deactivated and the ignition of the vehicle is turned on.

7. A method of controlling a vehicle, the method comprising:
identifying whether a mobile device is placed on a wireless charger;
determining, by a controller, whether a digital key registration mode is activated based on whether a predetermined activation condition is satisfied;
operating the wireless charger in a proximity communication mode in response that the digital key registration mode is activated;
performing, by the controller, registration of a digital key using digital key data obtained from the mobile device; and
providing, by a display communicatively connected to the controller, information related to the digital key registration.

8. The method of claim 7, further including:
deactivating, by the controller, the digital key registration mode in response that the predetermined activation condition is not satisfied or the digital key data is not obtained from the mobile device; and
re-determining, by the controller, whether the digital key registration mode is activated when the controller concludes that the mobile device is placed back after being disconnected from the wireless charger.

9. The method of claim 7, wherein the determining of whether to activate the digital key registration mode further includes:
in response to an ignition of the vehicle being turned on, a smart key being detected in the vehicle while parked, and a preparation signal being received from the mobile device,
determining that the activation condition is satisfied; and
activating the digital key registration mode.

10. The method of claim 9, wherein the providing of information related to the digital key registration further includes:
providing a notification of a non-preparation state of the mobile device in response to a failure to receive the preparation signal from the mobile device.

11. The method of claim 7, wherein the providing of information related to the digital key registration further includes:
providing a notification of an absence of the digital key data in response to a failure to obtain the digital key data from the mobile device.

12. The method of claim 7, further including operating the wireless charger in a charging mode in response that the digital key registration mode is deactivated and the ignition of the vehicle is turned on.

13. A system, comprising:
a mobile device; and
a vehicle including a controller, a wireless charger and a display communicatively connected to the controller,
wherein the controller of the vehicle is configured to:
identify a placement of the mobile device on the wireless charger;
determine whether a digital key registration mode is activated based on whether a predetermined activation condition is satisfied;
operate the wireless charger in a proximity communication mode in response that the digital key registration mode is activated;
perform registration of a digital key using digital key data obtained from the mobile device; and
control the display to provide information related to the digital key registration.

14. The system of claim 13, wherein the controller of the vehicle is further configured to:
deactivate the digital key registration mode in response that the predetermined activation condition is not satisfied or the digital key data is not obtained from the mobile device; and
re-determine whether the digital key registration mode is activated when the controller concludes that the mobile device is placed back after being disconnected from the wireless charger.

15. The system of claim 13, where the controller of the vehicle is further configured to:
in response that an ignition of the vehicle is turned on, a smart key is detected in the vehicle while parked, and a preparation signal is received from the mobile device,
conclude that the activation condition is satisfied; and
activate the digital key registration mode.

16. The system of claim 15, wherein the controller of the vehicle is further configured to control the display to provide a notification of a non-preparation state of the mobile device in response to a failure to receive the preparation signal from the mobile device.

17. The system of claim 13, wherein the controller of the vehicle is further configured to control the display to provide a notification of an absence of the digital key data in response to a failure to obtain the digital key data from the mobile device.

18. The system of claim 13, wherein the controller of the vehicle is further configured to operate the wireless charger in a charging mode in response that the digital key registration mode is deactivated and an ignition of the vehicle is turned on.
